(19) United States
(12) Patent Application Publication
(10) Pub. No.: US 2014/0368638 A1
(43) Pub. Date: Dec. 18, 2014

(54) METHOD OF MOBILE IMAGE IDENTIFICATION FOR FLOW VELOCITY AND APPARATUS THEREOF

(71) Applicant: NATIONAL APPLIED RESEARCH LABORATORIES, Taipei City (TW)

(72) Inventors: FRANCO LIN, HSINCHU CITY 30076 (TW); WEN-YI CHANG, HSINCHU CITY 30076 (TW); LUNG-CHENG LEE, HSINCHU CITY 30076 (TW); HUNG-TA HSIAO, HSINCHU CITY 30076 (TW); WHEY-FONE TSAI, HSINCHU CITY 30076 (TW); TAI-SHAN LIAO, HSINCHU CITY 300 (TW); SHUN-CHUNG TSUNG, TAIPEI CITY 100 (TW); JIHN-SUNG LAI, TAIPEI CITY 100 (TW); CHIN-HSIUNG LOH, TAIPEI CITY 100 (TW); SHIH-CHUNG KANG, TAIPEI CITY 100 (TW); YAO-YU YANG, TAIPEI CITY 100 (TW)

(21) Appl. No.: 14/307,658

(22) Filed: Jun. 18, 2014

(30) Foreign Application Priority Data
Jun. 18, 2013 (TW) 102121461

(51) Int. Cl. G01B 13/00; H04N 7/18

(52) U.S. Cl. CPC G01B 13/00; H04N 7/18
USPC 348/135

(57) ABSTRACT

The present invention provides a method of mobile image identification for flow velocity and the apparatus thereof. The present invention integrates laser-light module and mobile photographing devices such as smartphones, cameras, or tablet computers. After multiple laser spots are projected on the surface of flowing water, water-surface images including the laser spots are photographed continuously. Then the software program of image identification in the mobile photographing device performs calculations and coordinate conversion. According to the difference between multiple water-surface images taken continuously, the flow-velocity information of the water surface is given.

### FIELD OF THE INVENTION

The present invention relates generally to a method of mobile image identification for flow velocity and the apparatus thereof, and particularly to a method and the apparatus thereof that allow a user to measure the flow velocity of a remote current safely and accurately by combining the projection of laser spots with presently available mobile photographing devices.

### BACKGROUND OF THE INVENTION

The particle image velocimetry (PIV) adopts an optical method combining the technologies of flowing field visualization and digital image processing and has the property of non-contact full-field measurement for velocity. Its structure comprises roughly an optical vibration table, a synchronizer, an IR laser, a laser stimulator, and a high-speed camera.

In the early 1990's, most researches are focused on various measurements using PIV in laboratories. The earliest application of PIV in the research of rivers in the nature started in the mid-90's in Japan. Afterwards, the related applications of PIV in hydraulic engineering have been developing prosperously and towards large-scale PIV (LSPIV). In recent years, a main form of the development of LSPIV is the space-time image velocimetry, which uses band images for performing continuous measurement and acquiring the velocity of the monitored regions. Another development is the large-scale adaptive PIV, which can analyze the vector of flowing velocity on the raw images directly and then convert them to the correct scale. In addition, there is also a form called the real-time LSPIV (RTLSP)V). After five continuous months of monitoring the flow of rivers using the RTLSPIV and compared to the measurement data of USGS flow stations, it is found that both can give very accurate measurements with errors within approximately 10%. Moreover, in the mobile LSPIV (MLSPIV), the camera equipment, the computer, and the analysis software are installed in the utility vehicle. Thereby, deployment and monitoring to the riverside can be done with mobility and flexibility.

According to the above disclosure, the PIV measurement methods in the past are most fixed. It is because the PIV algorithm requires prior positioning for acquiring the coordinates of the reference points used as the fixed parameters for image identification. Thereby, their operational convenience is quite low.

Regarding to application fields, many regions of rushing water are located in the valleys with precipitous terrains or there is no flat and spacious paths for users to get close to the currents. Thereby, disposition of measurement apparatuses for monitoring currents is not appropriate. Besides, current measurements might take place in the condition of bad climate. At this time, approaching the rivers for measurements threatens the safety of measurement staffs.

Accordingly, how to enable measurement staffs to measure and observe current velocity remotely while maintaining the accuracy of measurement for satisfying the demands of various aspects has become a technical issue to be solved.

### SUMMARY

An objective of the present invention is to provide a method of mobile image identification for flow velocity. Multiple laser light sources first illuminate the surface of flowing water. Then continuous photographing and image analyses and processes are performed. Users do not need to perform short-distance measurements by approaching the water or place reference objects. Thereby, safety and convenience can be ensured.

Another objective of the present invention is to provide a method of mobile image identification for flow velocity. The method extends the measurement range to long distance by using the low dispersion property of laser beams. Even the distance is very long, the accuracy will not be influenced.

Another objective of the present invention is to provide an apparatus of mobile image identification for flow velocity, which can project the required laser light to the surface of flowing water for measuring accurate flow velocity using the method according to the present invention.

Still another objective of the present invention is to provide a device of mobile image identification for flow velocity, which can use the photographing and calculating functions of currently available smartphones or digital cameras directly.

For achieving the objectives described above, the present invention discloses a method of mobile image identification for flow velocity and the apparatus thereof. The method comprises steps of projecting a plurality of laser spots on a water surface; photographing continuously a plurality of water-surface images including the plurality of laser spots; acquiring reference coordinates of the plurality of laser spots in the plurality of water-surface images, respectively; calculating real coordinates of the plurality of laser spots, respectively; restoring the plurality of water-surface images to a plurality of orthogonal images; analyzing the plurality of orthogonal images for giving a plurality of flow-velocity vectors and analyzing the reference coordinates for giving a reference length of the plurality of laser spots; and combining the plurality of flow-velocity vectors and the reference length for giving the flow velocity on the water surface. According to the method and the corresponding appropriate apparatus, the present invention enables users to monitor and measure rushing current at precipitous locations.

### BRIEF DESCRIPTION OF THE DRAWINGS

FIG. 1 shows a flowchart according to the present invention;

FIG. 2A shows a front structural schematic diagram according to a preferred embodiment of the present invention;

FIG. 2B shows a rear structural schematic diagram according to a preferred embodiment of the present invention;

FIG. 3 shows a schematic diagram of the coordinates projected by parallel laser beams according to the present invention;

FIG. 4 shows a schematic diagram of photographing on a bridge according to the present invention;

FIG. 5 shows a front structural schematic diagram according to another preferred embodiment of the present invention;

FIG. 6 shows a schematic diagram of projecting using nonparallel laser light source according to the present invention; and

FIG. 7 shows a picture of the result of flow-velocity identification according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

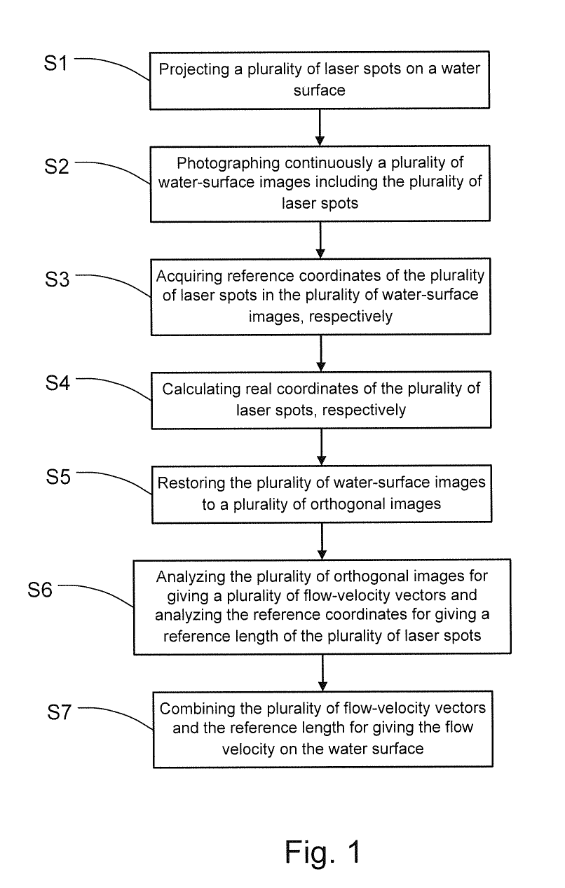

First, please refer to FIG. 1, which shows a flowchart according to the present invention. As shown in the figure, the method comprises steps of:

S1: Projecting a plurality of laser spots on a water surface;

S2: Photographing continuously a plurality of water-surface images including the plurality of laser spots;

S3: Acquiring reference coordinates of the plurality of laser spots in the plurality of water-surface images, respectively

S4: Calculating real coordinates of the plurality of laser spots, respectively;

S5: Restoring the plurality of water-surface images to a plurality of orthogonal images;

S6: Analyzing the plurality of orthogonal images for giving a plurality of flow-velocity vectors and analyzing the reference coordinates for giving a reference length of the plurality of laser spots; and

S7: Combining the plurality of flow-velocity vectors and the reference length for giving the flow velocity on the water surface.

According to the present invention, the direct projection of laser spots on the water surface and continuous photographing of the images are performed remotely. Then an apparatus having analyzing and calculating functions processes the acquired images real-timely for giving the information of the flow velocity on the water surface. In order to implement the steps in the method described above, related hardware equipment is required for supporting.

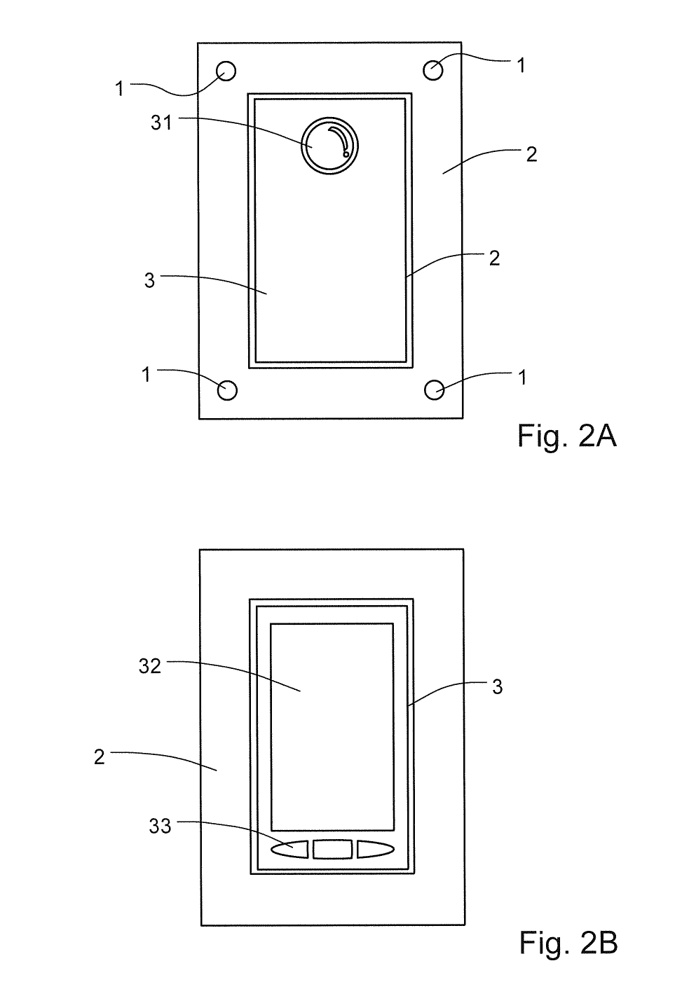

Please refer to FIG. 2A and FIG. 2B, which show a front and a rear structural schematic diagram of the apparatus according to a preferred embodiment of the present invention. The apparatus comprises a plurality of laser light sources 1, a frame 2, an accommodating space 21, and a mobile photographing device 3. The plurality of laser light sources 1 are disposed on the frame 2. The frame 2 has the accommodating space 21 at the center. The accommodating space 21 is used for accommodating and fixing the mobile photographing device 3 therein, so that the frame 2 surrounds the periphery of the mobile photographing device 3.

In addition, the mobile photographing device 3 has a lens 31 on a surface thereof for taking pictures or video recording. The lens 31 and the plurality of laser light sources 1 carried by the frame face the same direction. The other surface of the mobile photographing device 3 has a display unit 32 for displaying images and an operational unit 33 for commanding. The operational unit 33 can be formed integrally with the display unit 32 if the display unit 32 is a touch sensitive design.

In the embodiment shown in FIG. 2A, the plurality of laser light sources 1 according to the present invention are parallel laser light sources capable of emitting parallel laser beams. Take four laser light sources 1 for example. The laser light sources 1 are arranged in a rectangle and projected to the water surface perpendicularly. In other words, after the initial projection, the projection angle is move horizontally by a horizontal angle α and then vertically by a vertical angle β for adjusting the projection to the target water surface. Hence, when the laser light sources 1 are projected on the water surface, the relative coordinates of the formed laser spots can be calculated.

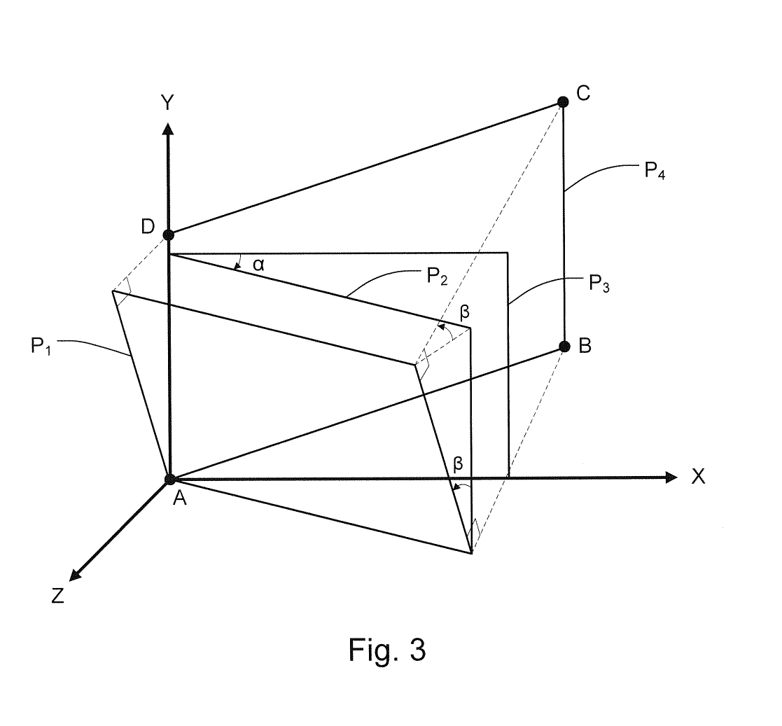

Take the parallel laser light sources described above for example. Please refer to FIG. 3. The first shape P₁ is the cross-section of the parallel laser beams emitted by the laser light sources 1. The second shape P₂ is modifying the first shape P₁ by the vertical angle β and perpendicular to the XZ plane. The third shape P₃ is modifying the second shape P₂ by the horizontal angle α and parallel with the XY plane. The fourth shape is P₄ the deformed shape of the laser light sources 1 on the water surface. The emitted shape of the laser light sources 1 includes multiple laser spots. The shapes P₁, P₂, P₃, P₄ in the figure are virtual laser shapes formed by connecting multiple laser spots; they are not real projected quadrilateral shapes.

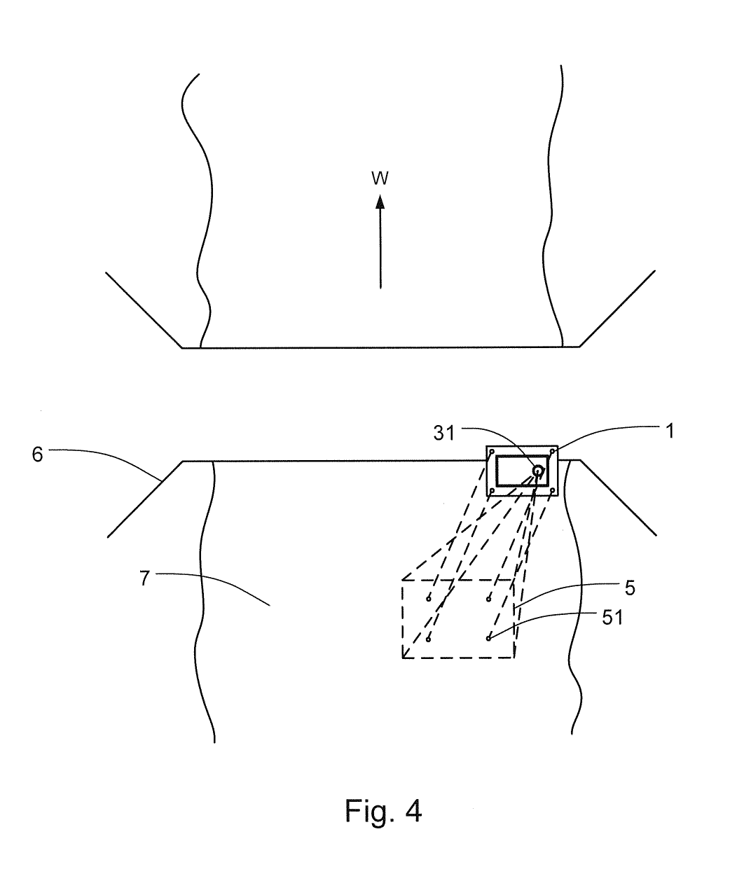

After the laser spots are projected on the water surface using the laser light sources 1, users can use the mobile photographing device 3 to photograph continuously. This mobile photographing device 3 is the currently available smartphones or digital cameras, which can be disposed in the accommodating space 21 in the frame 2 while being used and be removed after usage. The present invention uses the lens 31 of smartphones, tablet computers, or digital cameras for photographing continuously the laser spots and the flow filed on the water surface. Take FIG. 4 for example. A plurality of water-surface images 5 including the plurality of laser spots 51 are given by photographing the water surface 7 from the top of the bridge 6 and stored in the mobile photographing device 3. In this step, because the direction of the laser light sources 1 coincides with the direction of the lens 31 of the mobile photographing device 3, only the magnification of the mobile photographing device 3 should be adjusted for encompassing the range of the water surface to be measured.

Next, according to the present invention, the calculating and processing unit of the mobile photographing device 3 is used with related application programs (App) for analyzing the water-surface images acquired according to the above description. In this step, the reference coordinates of the laser spots 51 in the water-surface images 5 are confirmed first, respectively. According to the rotational vertical angle β and horizontal angle α and the following equations 1˜4 (taking four laser sources 1 for example), the real coordinates of the laser spots A, B, C, D on the water surface are calculated.

$$\begin{matrix}{( x , y )}_{A} = ( 0 , 0 ) & ( Eq . 1 ) \\ {( x , y )}_{B} = ( \frac{W}{cos α} , W tan α tan β ) & ( Eq . 2 ) \\ {( x , y )}_{C} = ( \frac{W}{cos α} , \frac{H}{cos β} + W tan α tan β ) & ( Eq . 3 ) \\ {( x , y )}_{D} = ( 0 , \frac{H}{cos β} ) & ( Eq . 4 )\end{matrix}$$

Then, the locations (x′,y′)_{A}˜(x′,y′)_{D} of the laser spots in the deformed water-surface images 5, which is just the water-surface images 5 taken by the mobile photographing device 3 and the deformation is due to non-vertical projection to the water surface, are identified using image processing technologies such as red-point detection software. Subtituting the coordinates of the four points A, B, C, D before and after deformation into the following equations 5 and 6 gives the coefficients C₁˜C₈:

x′=c₁x+c₂y+c₃xy+c₄ (Eq. 5)

y′=c₅x+c₆y+c₇xy+c₈ (Eq. 6)

Accordingly, given the known coefficients C₁˜C₈, the equations 5 and 6 can restore the deformed water-surface images to orthogonal images and give the reference length among the laser spots 51.

Afterwards, by analyzing the correlation among the plurality of water-surface images, a plurality of flow-velocity vectors are given. In this step, the flow-velocity image identification is performed by the PIV. According to the method, correlation analysis is performed on two successive orthogonal images with known time interval for calculating the moving direction and distance of water-surface track sources, such as splashes, floating objects, and suspended particulates. Then dividing the distance by the time interval gives the flow-velocity vector on the orthogonal images.

In addition, if the light is insufficient or measurement is performed at night, for enhancing the clarity of the water-surface images 5, other light sources can be used as well. The property of high concentration of laser light will not be influenced by the auxiliary light source. Moreover, in addition to displaying the identification result of the flow-velocity images on the display unit 32 directly, the device disclosed in the present invention can also upload the related flow-velocity information, water-surface images, and GPS coordinates to the cloud server using the 3G wireless transmission technology, Bluetooth, or Wi-Fi technology in the mobile photographing device 3 for preventing hazards by remote real-time monitoring.

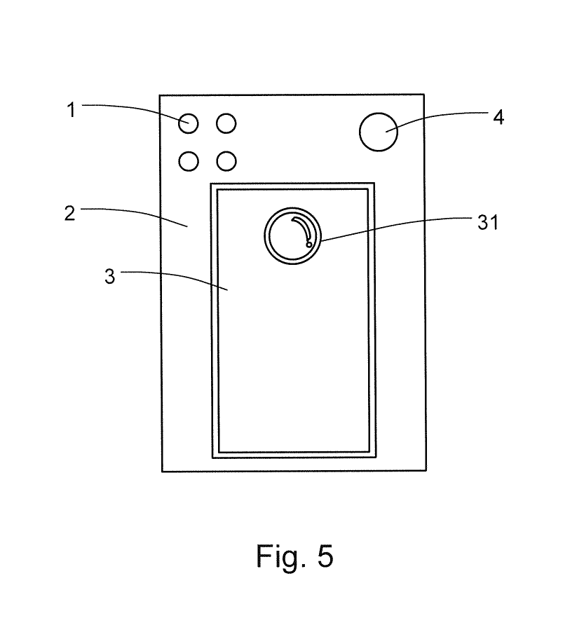

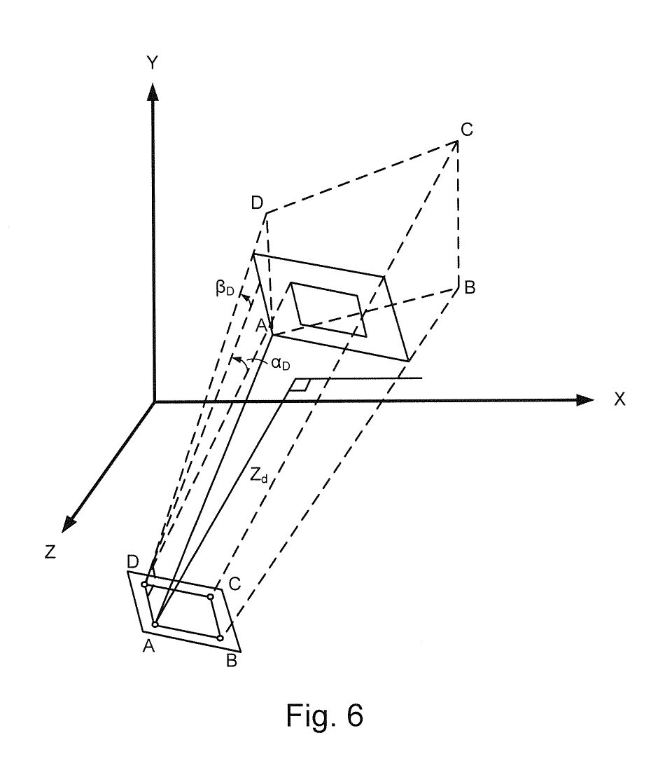

In addition to the parallel laser light sources, the present invention can also adopt non-parallel laser light sources for measurement. Please refer to FIGS. 5 and 6, which show a structural schematic diagram of the device and a schematic diagram of projection. The structure also includes multiple laser light sources 1. Nonetheless, the laser beams emitted by the plurality of laser light sources 1 are not parallel with each other. Instead, they form an angle α_{D} with the horizontal direction and an angle β_{D} with the vertical direction. The angles α_{D}, β_{D} can be varied according to the distance so that the quadrangle formed by the emitted laser spots can change its size. The structure further includes a range finder module 4 used for measuring the distance Z_{d} between the device according to the present invention and the water surface. Thereby, the enlarged size of the quadrangle formed by the laser spots can be deduced by geometry calculations. Then, according to the angle between the device according to the present invention and the normal of the water surface, the relative coordinates of the laser spots on the water surface can be calculated.

While using the non-parallel laser light sources, the operational procedure is the same as that for the parallel laser light sources. Nonetheless, the angles between the laser beams emitted by the four laser light sources 1 and the parallel laser beams should be taken into the calculation. Besides, while deducing the real coordinates of the laser spots A, B, C, D on the water surface, the following equation 7 is used instead:

$$\begin{matrix}\{ \begin{matrix}{( x , y )}_{A} = ( 0 , 0 ) \\ {( x , y )}_{B} = ( \begin{matrix}W cos α - \frac{( {X}_{d} + W sin α ) \text{?}}{\text{?}} + \frac{\text{?}}{\text{?}} - \\ \frac{( {X}_{d} + W sin α ) \text{?}}{\text{?}} + \frac{{X}_{d} \text{?}}{\text{?}}\end{matrix} ) \\ {( x , y )}_{C} = ( \begin{matrix}- H sin β sin α + W cos α - \\ \frac{( {X}_{d} + H sin β cos α + W sin α ) \text{?}}{\text{?}} \text{?} \\ H cos β - \frac{( {X}_{4} + H sin β cos α + W sin α ) \text{?}}{\text{?}} + \frac{{X}_{d} \text{?}}{\text{?}}\end{matrix} ) \\ {( x , y )}_{D} = ( \begin{matrix}- H sin β sin α - \frac{( {X}_{4} + H sin β cos α ) \text{?}}{\text{?}} + \frac{{X}_{d} \text{?}}{\text{?}} \text{?} \\ H cos β - \frac{( {X}_{4} + H sin β cos α ) \text{?}}{\text{?}} + \frac{{X}_{d} \text{?}}{\text{?}}\end{matrix} )\end{matrix} & ( Eq . 7 ) \\ \text{?} \text{indicates text missing or illegible when filed} & \end{matrix}$$

In the following, the non-parallel laser light sources are used for identifying the flow velocity. The steps comprise:

1. Start the laser light sources, the range finder module, and the camera used as the mobile photographing device and the application program stored therein. Dispose them on a bridge or both sides of the river bank aim them to the water surface for photographing downwards. The slanted angle between them and the water surface should be keep as close to 90° as possible for performing normal photographing. Thereby, the acquired information will be more abundant.

2. Extract two successive water-surface images by continuous photographing. The frame rate is 1/30 fps. The reading of the range finder module is 4.079 meters.

3. Use the red-point detection and identification software in the device for giving the reference coordinates of the laser spots on the images.

4. The angles of the calibrated laser light sources are:

α_{A}=0.2404, β_{A}=−0.0932

α_{B}=0.7334, β_{B}=−0.1293

α_{C}=0.8146, β_{C}=0.4204

α_{D}=0.3091, β_{D}=0.2985

And X_{D}407.9 centimeters can be given by the range finder module. By using the equations for non-parallel or parallel laser beams, the real coordinates of the four points A, B, C, D in the real space are (in centimeters):

A=(0,0)

B=(13.5100, −0.2571)

C=(14.0882, 8.6568)

D=(0.4891, 7.7886)

5. According to the reference coordinates on the images and the real coordinates in the real space, the normalization process can be performed to the two successive original images using orthogonal conversion. If the original photographing is close to 90°, the image information after conversion is less lost.

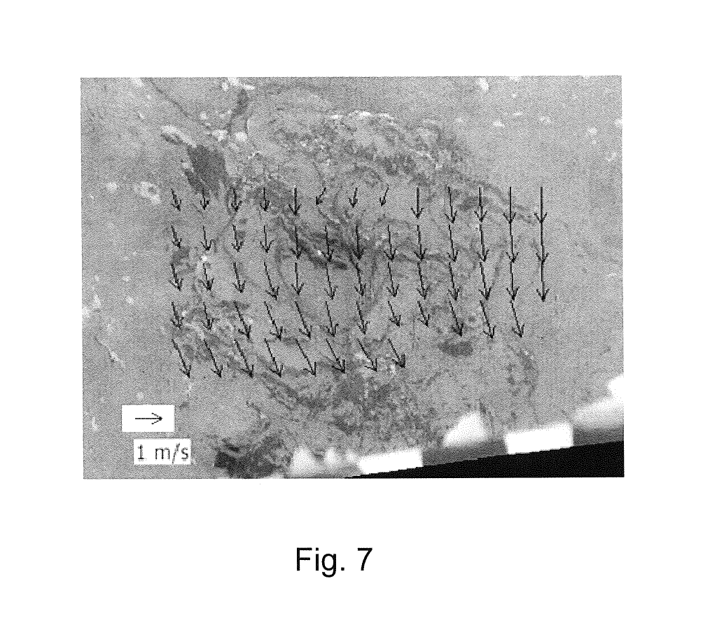

6. Use the PIV image identification technology to give a diagram of flow-velocity vectors. The unit of the vector diagram is pixel. Because the real space of image points after coordinate conversion is known, the result of flow-velocity identification as shown in FIG. 7 is given by adding the distances between points or labeling the distance on the horizontal and vertical axes.

By using the method described above and the corresponding hardware operations, the method of mobile image identification for flow velocity and the apparatus thereof disclosed in the present invention enables users to acquire sufficient information for calculating the flow velocity by projecting laser spots and photographing at a remote site from the flowing water. It is completely not required to approach the water or place a reference object. Thereby, it is safe and convenient. In addition, the popular smartphones or digital cameras are used directly with portability, enabling the application not limited by areas or environments. Hence, the present invention is quite flexible and easy to popularize. With the advantages of various aspects, the present invention undoubtedly provides an economical and practical method of mobile image identification for flow velocity and the apparatus thereof.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure. feature, or spirit described in the claims of the present invention are included in the appended claims of the present invention.

1. A method of mobile image identification for flow velocity, comprising steps of:
projecting a plurality of laser spots on a water surface;
photographing continuously a plurality of water-surface images including said plurality of laser spots;
acquiring reference coordinates of said plurality of laser spots in said plurality of water-surface images, respectively;
calculating real coordinates of said plurality of laser spots, respectively;
restoring said plurality of water-surface images to a plurality of orthogonal images;
analyzing said plurality of orthogonal images for giving a plurality of flow-velocity vectors, and analyzing said reference coordinates for giving a reference length of said plurality of laser spots; and
combining said plurality of flow-velocity vectors and said reference length for giving the flow velocity on said water surface.

2. The method of claim 1, wherein before projecting said plurality of laser spots on said water surface, said plurality of laser spots are first moved by a horizontal angle and a vertical angle.

3. The method of claim 2, wherein the number of said plurality of laser light sources is at least four.

4. The method of claim 1, wherein in said step of restoring said plurality of water-surface images to said plurality of orthogonal images, said plurality of reference coordinates and said plurality of real coordinates are used as restoring parameters.

5. An apparatus of mobile image identification for flow velocity, comprising:
a plurality of laser light sources;
a frame, carrying said plurality of laser light sources, and having an accommodating space at the center; and
a mobile photographing device, fixed in said accommodating space, having a lens, and said lens and said plurality of laser light sources facing the same direction.

6. The apparatus of claim 5, wherein said mobile photographing device is a digital camera, a smartphone, or a tablet computer.

7. The apparatus of claim 5, wherein said mobile photographing device has a display unit and an operational unit both facing opposite to the direction of said plurality of laser light sources.

8. The apparatus of claim 5, and further comprising a range finder module disposed on said frame and facing the same direction of said plurality of laser light sources.
